(19) United States
(12) Patent Application Publication
(10) Pub. No.: US 2015/0170096 A1
(43) Pub. Date: Jun. 18, 2015

(54) SYSTEM AND METHOD FOR ANALYZING HISTORICAL OPERATIONAL INVENTORY LAYERS

(71) Applicants: Michael F. Margolies, Owings Mills, MD (US); Philip H. WARRICK, Oakton, VA (US); Benjamin S. WHITE, Chatham, NJ (US); Sangbum LEE, Centreville, VA (US); Merryl J. MIRANDA, Stewartsville, NJ (US); Michiel Christiaan VAN DESSEL, Brockenhurst (GB); Darren Kenneth MEIERDIERCKS, Vienna, VA (US)

(72) Inventors: Michael F. Margolies, Owings Mills, MD (US); Philip H. WARRICK, Oakton, VA (US); Benjamin S. WHITE, Chatham, NJ (US); Sangbum LEE, Centreville, VA (US); Merryl J. MIRANDA, Stewartsville, NJ (US); Michiel Christiaan VAN DESSEL, Brockenhurst (GB); Darren Kenneth MEIERDIERCKS, Vienna, VA (US)

(73) Assignee: ExxonMobil Research and Engineering Company, Annandale, NJ (US)

(21) Appl. No.: 14/556,382

(22) Filed: Dec. 1, 2014

Related U.S. Application Data
(60) Provisional application No. 61/917,070, filed on Dec. 17, 2013.

(51) Int. Cl. G06Q 10/08

(52) U.S. Cl. CPC G06Q 10/087

(57) ABSTRACT

Systems and methods for determining an inventory layer for material stored in a plurality of storage units. The amount of material stored in each storage unit is measured. The activity status of each storage unit is categorized. An inventory layer is then determined based on the amount of material stored in each storage unit and the activity status of each storage unit. One or more batch characteristics can also be identified. The inventory layer and/or batch characteristics can be used to identify potential volume reductions.

### CROSS-REFERENCE TO RELATED APPLICATIONS

This application claims priority to U.S. Provisional Application Ser. No. 61/917,070 filed Dec. 17, 2013, herein incorporated by reference in its entirety.

### BACKGROUND

1. Field of the Invention

The present application generally relates to systems and methods for analyzing historical operational data relating to inventory layers. Particularly, the present application relates to systems and methods for analyzing historical operational data relating to inventory and breaking the inventory into inventory layers for purposes of enabling more efficient inventory management, scheduling and processing of materials stored in one or more storage units including but not limited to setting inventory targets and identifying potential inventory savings.

2. Description of the Related Art

High inventory holding costs drive continual efforts to reduce inventory layers. Achieving economic inventory reduction is not always obvious in a complex environment such as a refinery, where material is divided into many segregations, often involving multiple storage units with sophisticated interactions. Traditional inventory management typically involves determining inventory targets based on calculating how much material, on average, is required in each of several inventory layers based upon anticipated future needs. This approach, however, does not provide guidance on how to reduce inventory holding costs based on known historical operational data.

Therefore, there is a need for systems and methods that identify segregations with opportunities for economically reducing inventory based on historical operational inventory layers for each segregation for purposes of setting inventory targets.

### SUMMARY

The purpose and advantages of the present application will be set forth in and apparent from the description that follows. Additional advantages of the disclosed subject matter will be realized and attained by the methods, apparatus, and devices particularly pointed out in the written description and claims thereof, as well as from the appended drawings.

The presently disclosed subject matter is directed to a method for analyzing historical operational inventory levels for at least one storage unit at specified time intervals to decompose the inventory levels into inventory layers. The analysis of the inventory layers is used to set future inventory targets for the analyzed segregation. The analysis is also used to identify potential inventory savings or prizes and other potential volume reductions in inventory levels. Each of the at least one storage unit stores inventory. The method includes obtaining historical operational data for the at least one storage unit, wherein the historical operational data corresponding to the segregations at the specified time intervals. The method further includes categorizing, using a processer, an activity status of each storage unit at each of the specified time intervals. Categorizing the activity status of each storage unit comprises categorizing each storage unit as one of a filling status, static status, withdrawing status, or an idle status. When the activity status of a storage unit is categorized as static at a specified time, the method further includes subcategorizing the static status as one of either available or unavailable. The method includes identifying a multi-storage unit batch of inventory and refining the activity status of at least one storage unit in the multi-storage unit batch. The method further includes determining, using a processor, inventory layers for the inventory stored in the storage unit at the specified time interval. The inventory layers comprise: available static stock, unavailable static stock, idle stock, and cycle stock. Cycle stock includes withdrawing stock and filling stock.

Determining inventory layers for the material stored in the storage unit at the specified time interval and the activity status of the at least one storage unit includes establishing a reference safety stock for the inventory, allocating inventory to an effective safety stock, and determining inventory layers based upon any remaining inventory after allocating inventory to the effective safety stock. Allocating inventory to effective safety stock may include allocating available inventory, wherein available inventory includes idle stock, static available stock and withdrawing stock. Allocating available inventory to an effective safety stock includes allocating idle stock, then allocating static available stock and then withdrawing stock.

The presently disclosed subject matter is directed to a system that is capable analyzing historical operational inventory levels for the least one storage unit at specified time intervals to determine inventory layers. The determined inventory layers may be used to identify potential inventory savings and volume reductions. The determined inventory levels may also be used to set future inventory target levels.

The presently disclosed subject matter is also directed to a method of managing inventory layers for at least one storage unit storing inventory. The method includes (a) analyzing historical operational inventory layers for the least one storage unit at specified time intervals according to anyone of the preceding embodiments; and (b) adjusting inventory layer forecasts based upon the determined inventory layers.

It is to be understood that both the foregoing general description and the following detailed description are exemplary and are intended to provide further explanation of the application as claimed.

The accompanying drawings, which are incorporated in and constitute part of this specification, are included to illustrate and provide a further understanding of the apparatus of the application. Together with the written description, the drawings serve to explain the principles of the application.

### BRIEF DESCRIPTION OF THE DRAWINGS

FIG. 1 is a graphical representation of the activity status categorization of a storage unit in accordance with the presently disclosed subject matter.

FIG. 2 is a graphical representation of the activity status categorization of a storage unit including available and unavailable sub-status designation in accordance with the presently disclosed subject matter.

FIG. 3 is a graphical representation of the activity status characterization of a fill-side multi-storage unit batch.

FIG. 4 is a graphical representation of available inventory of a segregation as a subset of the total segregation inventory.

FIG. 5 is a graphical representation of the allocation of safety stock output by the system for a segregation in accordance with the methodology of the presently disclosed subject matter.

FIG. 6 is a graphical representation illustrating the correspondence between the hourly amount of inventory in each activity state and the hourly amount of inventory in each layer output by the system for a segregation in accordance with the presently disclosed subject matter.

FIG. 7 is a graphical representation of the average hourly amount of inventory in each layer over a predetermined time period in accordance with the methodology of the presently disclosed subject matter.

FIG. 8 is an example of a histogram illustrating a batch characteristic.

FIG. 9 is examples of histograms developed in accordance with the methodology of the presently disclosed subject matter illustrating potential skewness of the histograms.

FIG. 10 is a potential inventory savings or prize chart that can be displayed to a user in accordance with a representative embodiment of the disclosed subject matter.

FIG. 11 is a diagram of a representative embodiment of a system for analyzing historical operational inventory layers in a plurality of storage units in accordance with the disclosed subject matter.

FIG. 12 is a flow chart illustrating the method of analyzing a segregation in accordance with the presently disclosed subject matter.

### DETAILED DESCRIPTION

Reference will now be made in detail to embodiments of the disclosed subject matter, examples of which are illustrated in the accompanying drawings. The methods and systems presented herein are generally directed to a method and system for analyzing inventory layers for a segregation based upon historical operational inventory levels. The inventory layers are determined from an analysis of the historical operational inventory levels for particular segregation(s). From the analysis, inventory targets may be set taking into account the determined layers. From the analysis, potential volume reductions and other inventory savings or “prizes” may also be determined.

The term “segregation,” as used herein, refers to a grouping of materials that are counted as a single unit for inventory purposes. Each segregation contains multiple inventory layers including static and/or cycle stock, safety stock and heel stock. For purposes of explanation, the disclosed subject matter will be described with reference to a single segregation. However, those having skill in the art will recognize that the disclosed subject matter can also be used to determining inventory layers for multiple segregations by repeating the disclosed methods for each segregation.

The term “material,” as used herein, refers to the materials that comprise a segregation. A material can be a single material, such that the inventory layers for the material are determined separate and apart from the inventory layers of any other material. It is contemplated that material can include but is not limited to base materials, feedstocks, additives and other components necessary to produce intermediate and/or finished products. A material can also be a group of two or more materials. For example, where two materials are interchangeable for purposes of manufacturing (i.e., as inputs) or distribution (i.e., as outputs), the term “material” can encompass both materials. While the presently disclosed subject matter is disclosed in connection with refining and petrochemical processing applications, the presently disclosed subject matter is not intended to be limited to these applications; rather, the presently disclosed subject matter has application in any field where inventory management is a concern.

The disclosed subject matter can be used in connection with any material that is stored as described herein. For example, the material can be a bulk material. The term “bulk material,” as used herein, refers to any material that is unbound and substantially fluid as loaded; i.e., the material is in a loose unpackaged form. Examples of bulk materials include, but are not limited to petroleum products such as crude oil, high sulfur gas oil, liquefied natural gas, lubes feedstock, intermediate feedstocks, base stocks, additives, jet fuel, slop oil, bunker fuel oil, vacuum gas oil, and premium unleaded gasoline. It is also contemplated that bulk materials need not be limited to substantially fluid materials; rather, various solids and gases are considered to be within the scope of the presently disclosed subject matter.

The term “storage unit,” as used herein, refers to any storage container or similar receptacle, including tubs, vats, bins, rail cars, ships or other vessels and the like. The term. “storage unit” may also include pipelines. It is also contemplated that the term “storage unit” is not limited to containers or receptacles; rather, it is contemplated that the term “storage unit” may refer to a storage area (e.g., a pile of material stored in a yard, warehouse or other facility). The storage unit may be of any size provided it is capable of storing/holding material. The term “storage unit” can also refer to a subsection of a storage unit. For example, if a single storage unit is divided into several compartments, each of the compartments can be considered a storage unit. For purposes of explanation, the disclosed subject matter is described in connection with a material stored in a plurality of storage units. However, those having skill in the art will understand that the systems and methods disclosed herein are equally applicable to a material stored in a single storage unit. Similarly, if a particular material is not present at a particular location (i.e., if no storage units store the particular material or segregation), the disclosed systems and processes can recognize the absence of such material or segregation.

The plurality of storage units will generally be located at a single location or in close proximity thereto. However, the disclosed subject matter can also be used to determine an inventory layer for storage units at two or more locations. For example, if two locations are in close enough proximity that the inventory stored at each location is essentially interchangeable, storage units from both locations can be considered in determining an inventory layer.

The term “batch” as used herein refers to the amount or volume of material supplied to a storage unit or storage units from a vessel, pipeline or other suitable delivery system. For example, material that is supplied to a single storage unit from a delivery system may be referred to as a single storage unit batch. Material that is supplied to more than one storage unit may be referred to as a multi-storage unit batch. For example, the capacity of a tanker supplying material will often exceed the storage capacity of a single storage unit. As such, the material is located in several storage units and is collectively referred to as a multi-storage unit batch and more particularly a fill side multi-storage unit batch. The multi-storage unit batch is not intended to be limited to those storage units that are filled from the same vessel; rather, multi-storage unit batch may be used in the context of when multiple storage units supply material to a vessel or a process unit or the like. For example, material from a first storage unit is supplied. When the activity status of the first storage unit changes from withdrawing to idle, the second storage unit then supplies material. The material located in the several storage units is collectively referred to as a multi-storage unit batch and more particularly a withdraw side multi-storage unit batch. A multi-storage unit batch can be identified based on several criteria. Examples of suitable criteria include timing, fill rate, and withdrawal rate. Typically, multi-storage unit batches identify material that is loading or unloading from the same vessel. Multi-storage unit batches identified on the basis of fill activity are considered “fill-side,” or import, batches. Multi-storage unit batches identified on the basis of withdrawal activity are considered “withdrawal-side,” or export, batches. If a storage unit cycles without being part of a multi-storage unit batch, the cycle can be considered a single-storage unit batch.

In an exemplary embodiment, the plurality of storage units can be located at or in proximity to a facility. The disclosed subject matter can be used at any facility or location that stores material, petroleum-based or otherwise, as described herein. Examples of such facilities include a petroleum or petrochemical processing facility or unit. It is also contemplated that the facility may be a lube processing or blending facility where multiple additives and agents are stored for blending with a basestock for preparation of a lubricant, a fuel distribution center or pipeline or distribution terminal with storage facilities, and the like. It is also contemplated that the storage unit may be located between two processing facilities whereby the storage unit supplies materials to both facilities.

The amount of material stored in each of the storage units 10 is typically monitored at each facility or storage location. The material may be measured by counting or weighing the material present, estimating the volume of material present or any other suitable method for determining the amount material. It is contemplated that the measurement may be accomplished using sensors, flow meters, scales, gauges, bar code scans or any other device capable of measuring or determining the amount of material present in the storage unit. The amount of material stored in each of the units can be measured at a certain time (e.g., time t), so as obtain a snapshot of the total amount of material at time t. A historical reference may be compiled to identify normal or typical material usage at specified times or over a specified period, which may be used to determine future needs. In general, the amount of material in a unit can be measured or estimated using any suitable method as known in the art. This information may then be supplied to or accessed by the system 20 utilizing the analyzer in accordance with the presently disclosed subject matter. The user may identify particular segregations and related characteristics for the same at one or more facilities. The system 20 may then retrieve the relevant historical data related to the segregations and the facilities for processing in accordance with the presently disclosed subject matter.

The methodology in accordance with the presently disclosed subject matter for analyzing historical operational data relating to inventory layers includes four primary steps. These steps are preferably performed by a processor within the system 20. First, the activity status or operating state of each storage unit is categorized. This is preferably done at timed intervals. It is preferable that the categorization is based on an one hour increments or done on an hourly basis. Multi-storage unit batches are then identified to further refine the activity status of each storage unit. An appropriate portion of the inventory contained in each storage unit is then allocated to safety stock. The historical levels of each layer of the segregation contained in the storage tanks is then determined. The presently disclosed methodology provides historical operational levels of the inventory of each layer of each segregation contained in the storage unit and historical values for various inputs (including but not limited to average batch size and average fill/draw rates), which can highlight segretations having potential inventory reduction opportunities as well as provide a more intuitive visualization of the historical operating behavior of each storage unit.

The categorization of the activity status will now be described in greater detail. For every hour, the activity status for each storage unit is categorized. The activity status of the storage unit is categorized at a particular time t. In order to obtain an accurate snapshot of the inventory layers at a particular point, the activity status for each storage unit can be determined at the same time t as the amount of material in each of the storage units is measured or estimated.

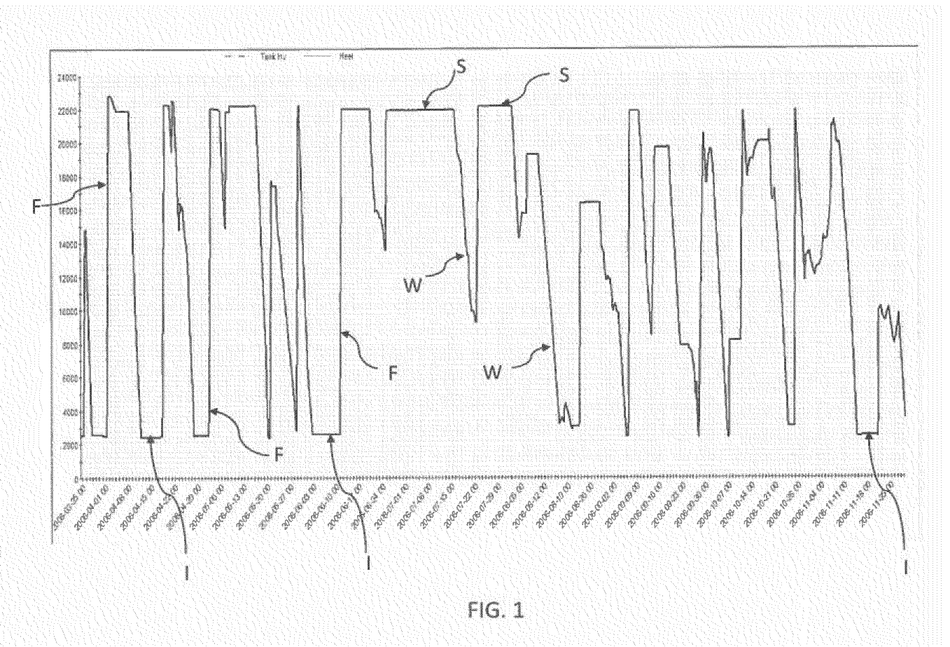

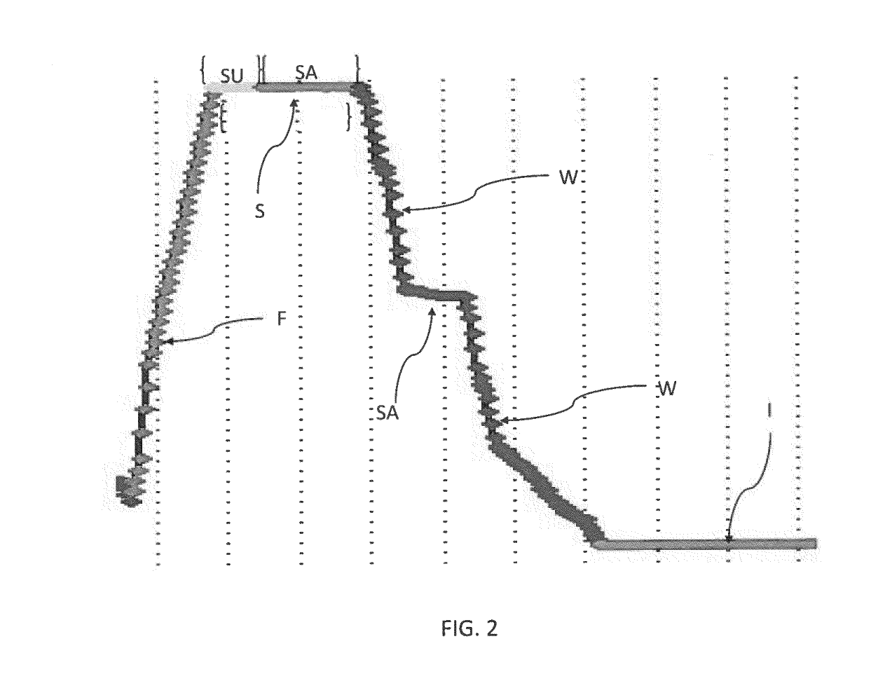

The activity status of each storage unit can be categorized as one of four states: filling, static, withdrawing, or idle. The four activity statuses or states are illustrated in FIGS. 1 and 2. An activity status of filling indicates that the material of a segregation is being deposited into the storage unit. An activity status of withdrawing indicates that the material is being removed from the storage unit. An activity status of static indicates that the storage unit is between (i) a filling stage and the withdrawing stage (although this does not necessarily mean that the storage unit is filled to capacity), (ii) a filling stage and subsequent filling stage (e.g., a pause between batches of material being filled into the storage unit where such pause may be associated with filling operations from multiple deliveries such as one or more deliveries from a ship or other vessel), or (iii) a withdrawing stage and subsequent withdrawing stage with no intermediate filling stage (e.g., a pause between batches being withdrawn from the storage unit). An activity status of idle indicates that the storage unit is between the withdrawing stage and the filling stage (i.e., an “empty” storage unit, although this does not necessarily mean that all the material has been removed from the storage unit).

The activity status of a storage unit can be determined in a variety of ways. For example, the activity status of the storage unit can be constantly monitored, such that categorizing the activity status requires only that the activity status at time t be ascertained. For example, the activity status for a storage unit at time t can be determined based at least in part on the amount of material stored in the storage unit at times t−1 t, and t+1. If the amount of material in the storage unit at time t−1 is more than the amount of material stored in the storage unit at time t, and the amount of material stored in the storage unit at time t+1 is less than the amount of material stored in the storage unit at time t, then the activity status of the storage unit at time t can be categorized as withdrawing. If the amount of material in the storage unit at time t−1 and time t+1 is the same as the amount of material in the storage unit at time t, however, additional information is needed to categorize the storage unit as either static or idle. If the amount of material stored in the storage tank at time t is greater than t−1 the activity status at time t can be categorized as filling.

With reference to FIGS. 1 and 2, during a filling state or filling activity status for a storage unit or units, there is generally an increase in the amount of material contained in the storage unit. In the plots illustrated in FIGS. 1 and 2, there is a generally positive slope during the filling state. Several examples of filling states or filling activity status for a particular storage unit are denoted by F in FIGS. 1 and 2. During a withdrawing activity status or withdrawing state associated with the storage unit or units, there is generally a decrease in the amount of material contained in the storage units. This is represented by a plot having generally negative slope. Several withdrawing states W are illustrated in FIGS. 1 and 2. During a static activity status or static state, there is generally no or minimal change in the amount of material contained in the storage unit(s). The plot representing the static state has a zero or near zero slope. Several static states S are illustrated in FIGS. 1 and 2. Like the static activity state, there is no or minimal change in the amount of material in the storage unit(s) during an idle activity status or idle state. The slope of the plot corresponding to the idle state. Several idle activity states I are illustrated in FIGS. 1 and 2.

The static activity status of each storage unit can be sub-categorized as one of available or unavailable. A static sub-activity status of available indicates that the material in the storage unit is ready to be used. The storage unit having an available sub-status can be referred to as an “available storage unit.” An activity status of unavailable indicates that the material in the storage unit is not ready for use. The material in the storage unit when the storage unit has an unavailable sub-status is awaiting processing (e.g., certification for use, testing, settling, etc.). For example, some materials must be certified before being removed from the storage unit (e.g., for purposes of loading the material onto a vessel and transporting it to another destination). Other materials need to undergo additional processing before they are available for use. For example, certain petroleum materials need to be dewatered before they enter a process unit. Whether the material in a storage unit available or unavailable can be specified by the user, determined based on objective factors, or determined based on factors specified by the user. FIG. 2 illustrates the available and unavailable sub-activity status during a static state. Typically, an unavailable static state SU occurs after filling such that the material in the storage unit can undergo further processing. The available static state SA occurs after the unavailable static state SU or between sequential withdrawing operations, as shown in FIG. 2. The categorization can be based on a wait period. If the activity sub-status has been static longer than the wait period, the activity sub-status can be categorized as static available. Otherwise, the activity sub-status can be categorized as static unavailable. The wait period can be the certification time, the dewater time, or any other period of time specified (e.g., by a user, plant/facility type, historical data relating to, for example, certification data).

The refining of the activity status or operating state will now be described in greater detail in connection with the identification of the batch type. The batch type may be determined based upon how the material is supplied to the storage unit(s). The material may be supplied as a single storage unit batch whereby the material is delivered from a vessel, pipeline or other supply device to a single storage unit. In the event that the volume or amount of material contained in the vessel, pipeline or other supply device exceeds the storage capacity of a particular storage unit such that more than one storage unit is required to store material from the vessel, the material may be supplied as a multi-storage unit batch whereby the material is delivered from the vessel, pipeline or other supply device to more than one storage unit. In order to properly track inventory layers within the storage units, it is desirable to further refine the activity status of the storage unit(s) based upon whether or not the storage unit is classified as part of a single batch or multi-storage unit batch. Material stored in more than one storage unit is still considered a single segregation. The activity status of a particular storage unit may differ based upon whether or not it contains a multi-storage unit batch of material.

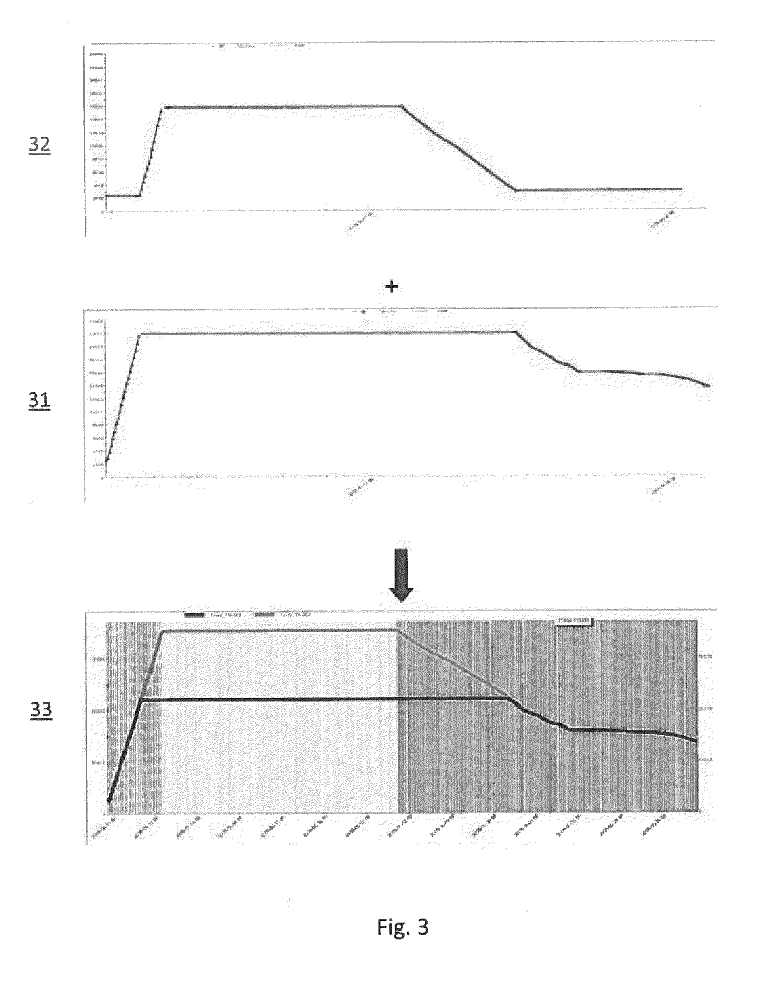

An example of a multi-storage unit batch is illustrated in FIG. 3. FIG. 3 represents the activity status of a fill side multi-storage unit batch delivered from the same vessel. The vessel supplies material to a first storage unit represented by the status plot 31 in FIG. 3. The supply of material to a second storage unit is represented by the status plot 32 in FIG. 3. As material is supplied to the first storage unit, the first storage unit has a filling activity status or in a filling state and the second storage unit has an idle activity status or idle state. Upon completion of the filling operation in the first storage unit, filling is commenced in the second storage unit. The second activity status in the first storage unit changes from filling to static with a sub-status of unavailable. The activity status of the second storage unit changes from idle to filling. Upon completion of the filling operation in the second storage unit, the activity status for the second storage unit changes from filling to static. Material is first withdrawn from the second storage unit and the activity status of that storage unit changes from static to withdrawing. The first storage unit remains in a static state. Upon completion of the withdrawing operation in the second storage unit, the activity status changes from withdrawing to idle. Material is now withdrawn from the first storage unit whereby the activity status of the first storage unit changes from static to withdrawing. Upon completion of the withdrawing operation, the activity status of the first storage tank changes from withdrawing to idle.

The status plots 31 and 32 of the first and second storage units have been combined into a single plot 33, which reflects the activity status and volume of the material contained in the multi-storage tank batch. By combining the first and second storage unit plots, the duration of the static activity status is diminished and more accurately reflects the inventory cycle. Without identifying the multi-storage unit batch, the activity status of the second storage unit would, at times, be incorrectly identified as static rather than as part of a cycle. Each storage unit in the multi-storage unit batch is therefore categorized as static only during the time when the entire batch is static (i.e., during the time represented by the shaded section in FIG. 3). If each of the storage units in the multi-storage unit batch were tracked and analyzed alone, the scheduler may order replacement material too soon (based upon plot 31) or delay ordering material (based upon plot 32) because it appears that there is a delay in using material from the first storage unit. Similar mischaracterizations could be made if the plots 31, 32 and 33 represented a withdraw side multi-storage unit batch.

Upon refinement of the activity status of the storage unit based upon batch type determination, the inventory contained in the storage unit or units is categorized in layers. The inventory contained in each storage unit may be characterized as one of static stock, cycle stock, safety stock and heel stock. Materials dispensed from the storage unit typically fall within the category of cycle stock. Materials being deposited into the storage unit during a fill may also be referred to as cycle stock. The cycle stock is typically used to supply material to the facility. Materials that are awaiting processing are referred to as static stock. Safety stock refers to material contained in the storage unit that is earmarked for contingencies in the case of an unanticipated event. Balance stock refers to the situation when safety stock is dispensed from the storage unit. An objective of the presently disclosed subject matter is to avoid the dispensing of balance stock while minimizing the amount of safety stock based upon a prediction of usage based upon a historical review of inventory layers.

A portion of the material contained in the storage unit may be classified as a heel stock. The term “heel”, as used herein, refers to undrawable stock. Such classification can be based on the quality of the material stored in the storage unit. It can also be based upon its location within the storage unit. For example, material may be withdrawn from the unit from a discharge port. The location of the discharge port within the storage unit may prevent all material from being removed. The portion of stock that cannot be withdrawn is classified as heel stock. The heel stock amount does not have any effect on the calculation of inventory layers, as it generally cannot be allocated to cycle or safety stock, and therefore is not discussed in detail herein. Heel stock may, for example, in the crude oil context contain precipitates or other foulants that if fed or supplied to the facility could impact performance of the unit or quality of the finished product(s). Heel stock is not part of safety stock. It is not intended to be used as such.

Inventory targets for each segregation are determined based upon based upon calculating how much material on average, is required in each of the layers in the segregation. The analysis of the historical operational layers in accordance with the presently disclosed subject matter will assist in further defining and refining the amount of material needed for each layer.

The calculation of the segregation layers will now be described in greater detail. In order to accurately calculate segregation layers, a portion of the material must first be allocated as safety stock. It is important to allocate the safety stock first because this layer can include material that would otherwise count toward the other inventory layers. For example, a full storage unit is typically, for inventory purposes, counted as static stock. Safety stock however is not treated as static stock, as such to avoid double counting the inventory, the material counted as safety stock should not be included in the amount of static stock. As used herein, allocation of material to or as safety stock refers to determinations regarding the identity and/or amount of material to be deemed safety stock for purposes of determining an inventory layer. Allocation of material as safety stock has no practical effect on the material.

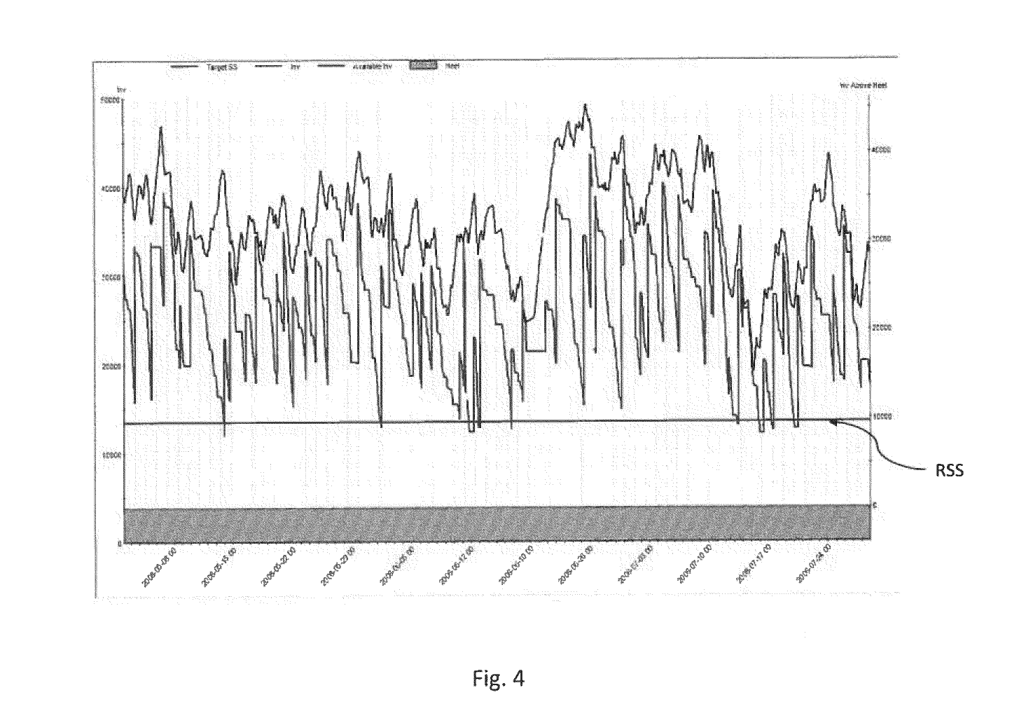

Although target safety stock or reference safety stock is primarily constant (with the exception of situations like seasonality, etc), effective safety stock can change in both quantity and location. At any given moment, the effective safety stock may be above or below the reference safety stock. To meet the reference safety stock, effective safety stock can shift, between tanks. In accordance with the presently disclosed subject matter, material can only count toward safety stock if it is “available” for its disposition. With reference to FIG. 2, material that has a filling activity status F or material that has a static activity status with an unavailable sub-status SU is not considered to be available for purposes of the calculation of safety stock. Material that has a static activity status with a sub-status of available SA, material having a withdrawing activity status W and material having idle activity status I are considered to be available for purpose of determining a safety stock allocation. With reference to FIG. 4, the available inventory denoted by line AI is a subset of the total segregation inventory TI. Heel stock HS is that portion of the total segregation that cannot be attributed to safety stock and any other layers for the reasons discussed above. The reference safety stock is illustrated as line RSS in FIG. 4.

An example of allocating material as safety stock will know be described. First, a reference safety stock (“RSS”) amount is determined. The reference safety stock amount can be determined based on user input. For example, the user may enter a reference safety stock amount via a user interface. Alternatively, the user can input certain parameters, the system 20 can calculate a reference safety stock amount based on the parameters. For example, the system can calculate a reference safety stock amount by adjusting an amount entered by a user to account for seasonality.

Material stored in available storage units can then be allocated as safety stock. This can be done on an hourly basis. Available inventory in the segregation is allocated toward the reference safety stock in a priority order: (i) idle stock; (ii) static available stock (SA); and (iii) withdrawing stock. It should be understood that, whenever material is referenced as being allocated to safety stock, any material in excess of the reference safety stock will not be allocated as safety stock The effective safety stock at a given time is determined based upon the following relationship:

ESS=RSS+Balance Stock+Excess idle Stock

When the available inventory is above the reference safety stock (RSS), the balance stock will be 0 and the excess idle stock will have a positive value. The effective safety stock (ESS) will have a value greater than the reference safety stock (RSS). When the available inventory is below the reference safety stock (RSS), the balance stock will be negative and the excess idle stock will be zero. The effective safety stock (ESS) will have a value less than the reference safety stock (RSS). If available inventory exceeds the reference safety stock, remaining material counts toward the other layers.

As discussed above, the reference safety stock amount for each storage unit is determined. The system 20 then allocates the stock layers to safety stock. Idle stock is allocated to the safety stock. The system 20 then determines whether the safety stock amount (i.e., the amount of material allocated to the safety stock) is equal to the reference safety stock amount. If the safety stock amount is equal to the reference safety stock amount, the reference safety stock amount has been satisfied by the idle stock and no further allocation to safety stock is necessary. If the amount of idle stock exceeds the reference safety stock, the excess is labeled as excess idle stock. If the amount of idle stock does not exceed the reference safety stock, the system 20 proceeds to allocate static available material to safety stock. The system 20 then determines whether the safety stock amount is equal to the reference safety stock amount. If the safety stock amount is equal to the reference safety stock amount, the reference safety stock amount has been satisfied by the idle material and the static available material, and no further allocation is necessary. Any excess static available stock will remain static available stock. Otherwise, the system 20 allocates the withdrawing material to the safety stock. This process can continue until the reference safety stock amount is satisfied or until no more material is eligible. The term “eligible”, as used herein, refers to material that can be allocated to the safety stock. In an exemplary embodiment, all material is eligible and, if necessary, can be allocated to safety stock. Alternatively, only a subset of the material (e.g., only idle material and static available material) can be considered eligible.

For example, a particular segregation has a reference safety stock of 170 kB. At a given time, the segregation has 150 kB having an idle activity status, 30 kB having a static available status and 20 kB having a withdrawing activity status. For this segregation, all 150 kB of idle stock and 20 kB of the static available material will count toward the safety stock. Only the remaining 10 kB of static available material will be attributed to the static stock layer. All 20 kB of the withdrawing material will count toward cycle stock.

In another example, a particular segregation has a reference safety stock of 170 kB. At a given time, the segregation has 180 kB having an idle activity status, 30 kB having a static available status and 20 kB having a withdrawing activity status. For this segregation, 170 kB of idle stock will count toward the safety stock. The remaining 10 kB of idle stock and 20 kB of the static available material will be attributed to the static stock layer. The additional 10 kB of idle stock above the reference safety stock is considered to be “excess idle stock” that represents operations above the reference safety stock. All 20 kB of the withdrawing material will count toward cycle stock.

In yet another example, a particular segregation has a reference safety stock of 170 kB. At a given time, the segregation has 100 kB having an idle activity status, 30 kB having a static available status and 20 kB having a withdrawing activity status. In this case, there is only 150 kB total of available material. All of this material would count toward the safety stock (that is, none of it would count toward cycle stock). In this example, available inventory is below the reference safety stock or 20 kB short of the reference safety stock. When available inventory is below the reference safety stock, material is being withdrawn from the safety stock. This is accounted for as negative “balance stock.” In this example, there is −20 kB of balance stock.

Each inventory layer can be calculated periodically in order to provide obtain an overview of the inventory layer over time. For example, the inventory layer can be calculated every hour, day, week, month, year, or at any other regular interval. The periodic inventory layers may be averaged over a number of periods. For example, the hourly inventory layers may be averaged over the entire year to determine an average inventory layer.

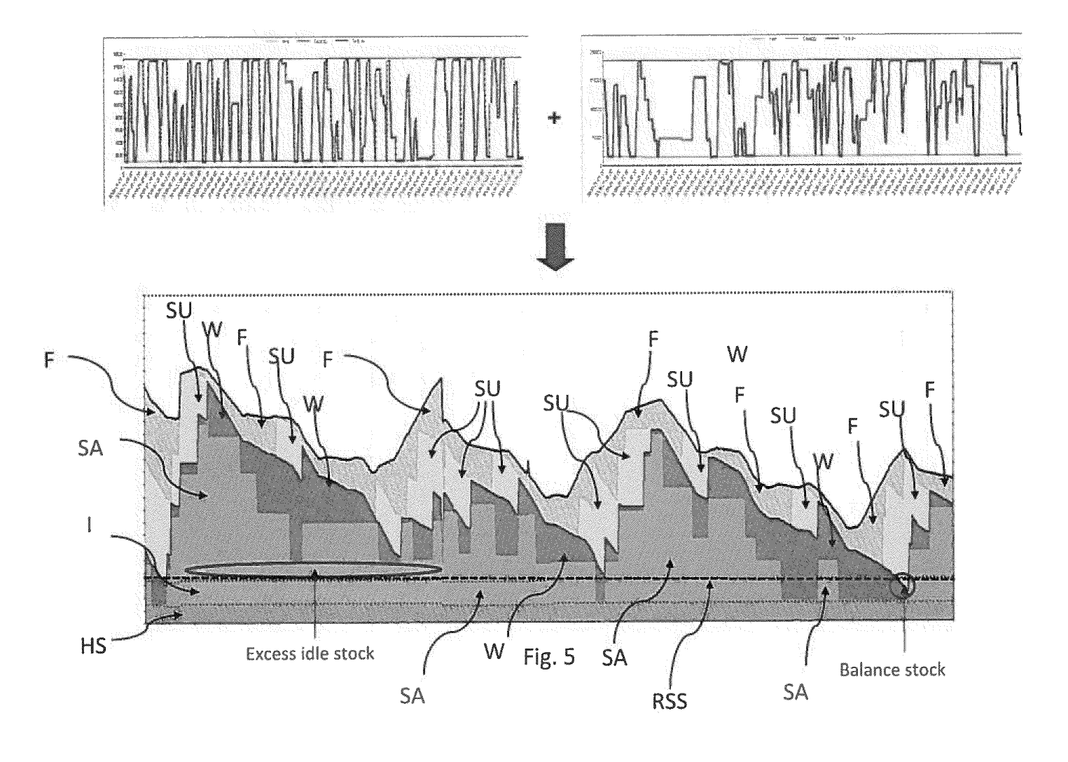

FIG. 5 illustrates the safety stock allocation over time for a particular segregation where all inventory is not considered available. The upper two plots in FIG. 5 represent the activity status of a pair of storage units. The lower graph represents an aggregation of the inventory from the storage units prepared by the system 20. In the lower graph, the aggregated inventory in the segregation is divided into sections representing the amount in each state. The sections are stacked in order of safety stock allocation priority. The lower most portion is identified as heel stock (HS) and is not allocated to safety stock. The reference safety stock layer is illustrated by line RSS. The remaining layers are stacked in order of safety stock allocation: idle I, static available SA, W, SU and F. Available material below the RSS line will count toward safety stock. Anything static available or withdrawing above the RSS line will count toward the other layers. Idle material above this line is considered excess idle stock. When the total amount of available material is below line RSS, balance stock exists.

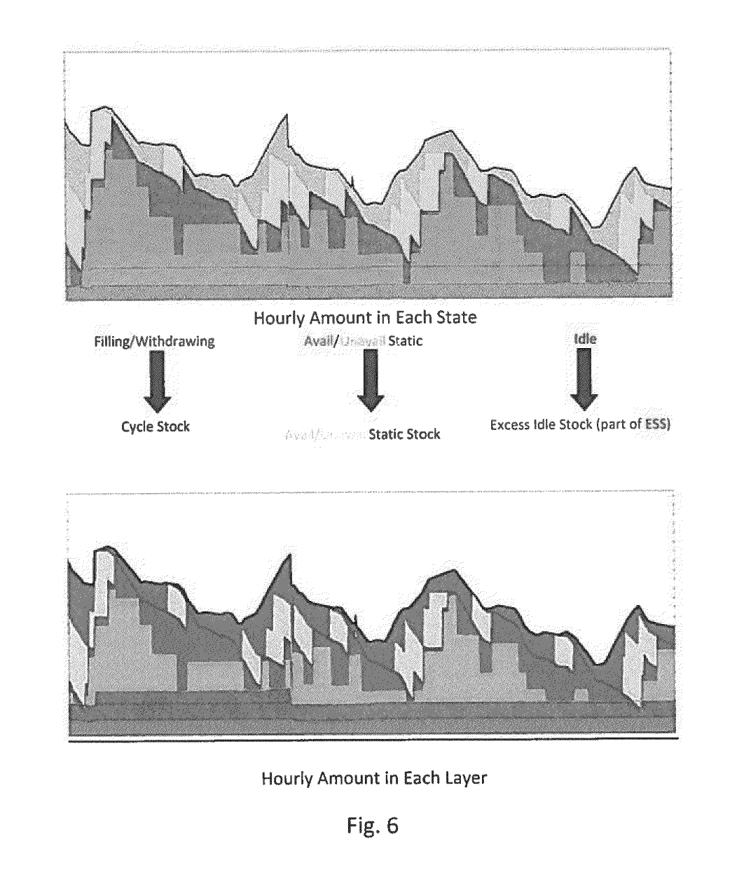

After allocating the appropriate portions of the inventory toward safety stock at each hour, hourly layers for the other layers are determined by summing remaining material in the corresponding states. For example, all filling/drawing material not counting toward safety stock is considered cycle stock. The upper graph in FIG. 6 corresponds to the lower graph in FIG. 5. The lower graph in FIG. 6 illustrates the corresponding hourly amount of material in each layer. The hourly amounts are classified as (i) cycle stock CS, which contains filling and withdrawing, (ii) available static stock, which includes available static, (iii) unavailable static stock includes unavailable static, and (iv) excess idle stock, which includes ESS. For all storage units tk in the segregation at time t, the hourly layer amounts are calculated as follows:
Cycle Stock (t)=Σₜₖ[Inv(tk,t)−Heel(tk)]−RSS component, $tk filling/drawing
Available Static Stock (t)=Σₜₖ[Inv(tk,t)−Heel(tk)]−RSS component, $tk static avail
Unavailable Static Stock (t)=Σₜₖ[Inv(tk, t)−Heel(tk)]−RSS component, $tk static unavail
ESS(t)=Excess Idle Stock+RSS+Balance Stock
   Where
   Excess Idle Stock (t)=Σₜₖ[Inv (tk,t)−Heel(tk)]−RSS component, $tk idle
   RSS=based on user inputs; subtracted in prior order from other layers
   Balance Stock (t)=unmet RSS (negative)
Heel(t)=ΣₜₖHeel(tk),

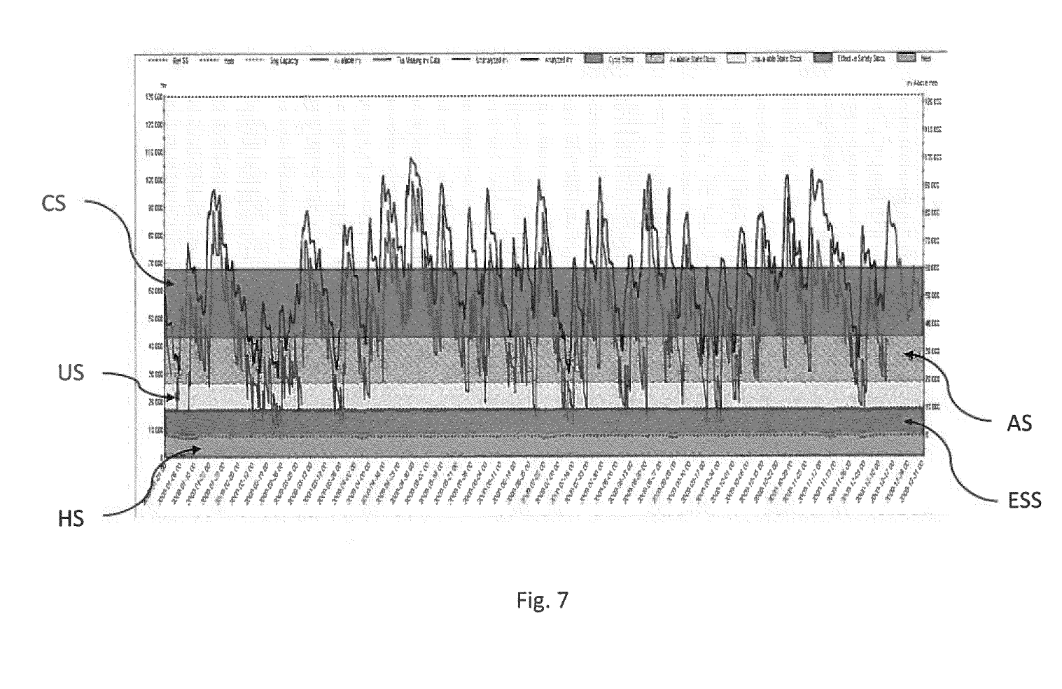

After the hourly layer amounts are calculated in the above manner, the amounts are then average over the entire year to derive reported layers. The calculations are preformed using a processor within the system 20. Cycle stock CS, available static stock AS, unavailable static stock US, ESS and heel stock HS are illustrated in FIG. 7.

In addition to inventory layers, segregation batch characteristics may be analyzed through several histograms. One or more batch characteristics can also be identified. Examples of batch characteristics include drawable stock at min, available stock at min, stock at max, available ullage at max, batch size, fill rate, and draw rate. Drawable stock at min is a measure of the amount of material at fill begin (for single-storage unit batches and multi-storage unit fill batches) or withdrawal end (multi-storage unit withdrawal batches). Available stock at min is the same as drawable stock at min, but excludes any material that is ineligible. Stock at max is a measure of the amount of material at fill end (multi-storage unit fill batches) or withdrawal begin (single-storage unit batches and multi-storage unit withdrawal batches). Available ullage at max is a measure of the ullage at fill end (multi-storage unit fill batches) or withdrawal being (single-storage unit batches and multi-storage unit withdrawal batches). Batch size is the fill amount (for single-storage unit batches or multi-storage unit fill batches) or withdrawal amount (multi-storage unit withdrawal batches).

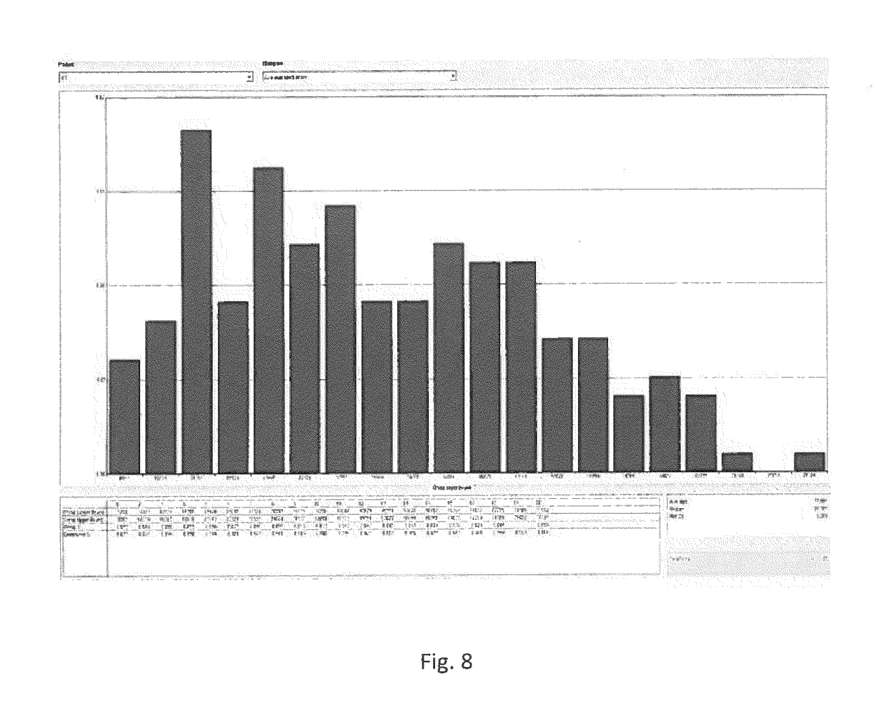

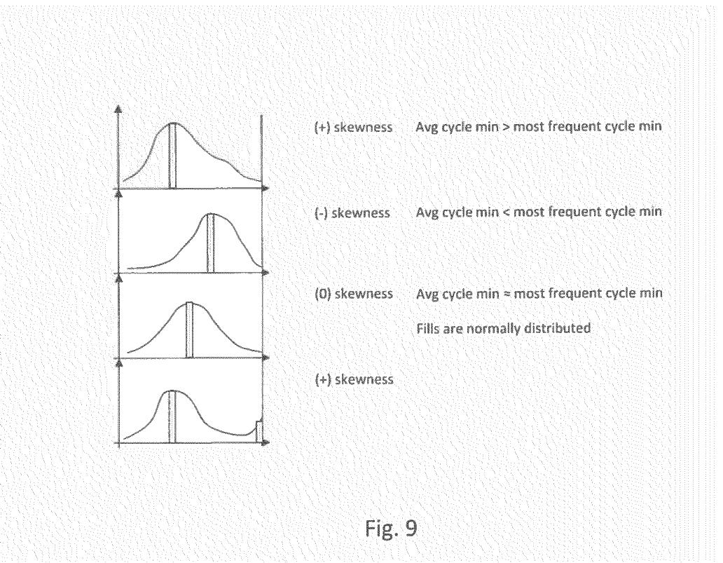

A batch characteristic can be represented by a histogram. With reference to FIG. 8, an exemplary histogram of available stock at min is shown. An important characteristic of a histogram is the skewness. Examples of the skewness of an available stock at min histogram are shown in FIG. 9. The top or first histogram has a positive skewness, indicating that the average cycle min is greater than the most frequent cycle min (i.e., the average fill point is above the most frequent fill point). The positive skewness of the histogram indicates that the segregation may be operating with early fills, leading to higher inventory layers. Elimination of early fills, which reduces the positive skewness towards a normal distribution (i.e., lowers the average cycle min to the most frequent value), reduces the overall average inventory layer.

The second histogram has a negative skewness, which indicates that the average cycle min is less than the most frequent cycle min. A normal skewness is shown in the third histogram indicates that the average cycle min is approximately equal to the most frequent cycle min (i.e., the fills are normally distributed). The bottom or fourth histogram indicates a unique situation, which represents an inconsistent pattern of supply or demand. This may be indicative of a sporadic supply or demand.

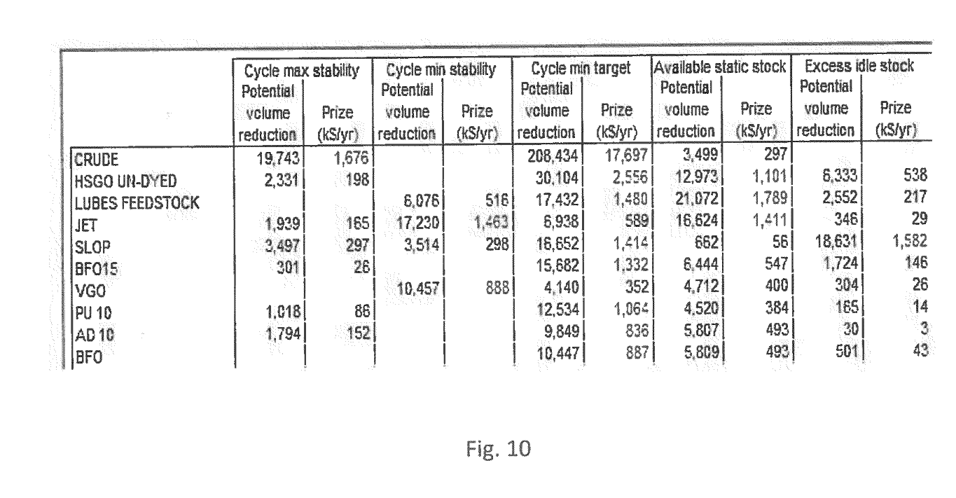

FIG. 10 illustrates a chart that can be displayed to a user in connection with an exemplary embodiment of the disclosed subject matter. The chart in FIG. 10 displays potential volume reductions and inventory savings or prizes for a number of inventory savings categories. The inventory savings or prizes refer to potential volume and/or monetary savings associated with potential adjustments to the inventory levels based upon the determined layers. The chart includes data for a plurality of segregations.

Potential volume reductions and inventory savings/prizes can be calculated for one or more prize categories. A prize category is any measure that reflects a potential volume reduction including but not limited to cycle max stability, cycle min stability, cycle min target, available static stock, and excess idle stock. The savings/prize may also include a potential reduction in the number of refill operations or an increase in the performance of draw down operations of layers that do not need to be replaced. The contemplated savings may be reflected in monetary units, but other units including but not limited to barrels may be used to quantify the potential savings. The system 20 calculates potential savings based, for example, upon an input monetary value. If the material is a crude oil, the price of crude oil may be used to calculate the potential savings. The system can calculate potential savings that may result from reductions in overall inventory levels, reductions in specific inventory layers, the adjustment of the timing of refill operations or the elimination of storage units.

For each savings/prize category, a potential volume reduction is calculated. The potential volume reductions can be calculated based on inventory layers or batch characteristics. For example, the potential volume reduction for cycle max stability can be calculated as the difference between the average and most frequent stock at max (which corresponds to the reduction of a histogram with positive skewness toward normal distribution). The potential volume reduction for cycle min stability can be calculated as the difference between the average and most frequent available stock at min (which corresponds to the reduction of a histogram with positive skewness to normal distribution). The potential volume reduction for cycle min target can be calculated as the difference between the lower of the average available stock at min or the most frequent available stock at min and the reference safety stock.

A savings/prize can also be calculated for one or more prize category based on the potential volume reduction. The prize can be a dollar prize based on a specified value for the particular segregation. The prizes can be calculated to accurately reflect the potential savings. Alternatively, the prize can be calculated in order to highlight segregations with potential volume reduction opportunities, and need not represent an actual cash amount. Moreover, the prizes need not be additive (i.e., the potential volume reductions may overlap).

In an exemplary embodiment, the highest potential volume reductions and/or prizes are highlighted. This may be accomplished by the use selecting a threshold value or level of savings. Potential savings exceeded the threshold level may then be hightlighted. Highlighting can include displaying the potential volume reduction and/or prize in a particular color (e.g., red), displaying a box around the potential volume reduction and/or prize, or similar techniques.

The calculated “prizes” are not meant to be taken as literal cash amounts available. Rather, these are merely simple, high-level calculations meant to help prioritize which segregations to examine in more detail. The prize calculations do not necessarily mean that the indicated inventory reductions can realistically be achieved. For example, the “cycle min target” prize assumes that the average available stock at min is reduced to the reference safety stock. If this were the case, half of all fills would occur below the reference safety stock, which is unrealistic operation. The purpose of this prize is to highlight segregations operating well above the reference safety stock layer. Furthermore, not all of the prizes are additive. For example, say a segregation has a large prize in both “cycle min stability” and “available static stock.” A “cycle min stability” prize is likely caused by early fills, and an “available static stock” prize indicates that tanks are being kept full for too long. If the early fills are reduced, this will also inherently reduce the amount of time tanks are kept full. The overlap means that there are two ways to look at what is largely the same excess inventory. Only certain prizes are explicitly additive: (i) two layer prizes that represent two different parts of the inventory; and (ii) two cycle min prizes—the stability prize is associated with reducing the average to the most frequent layer, and the target prize is the additional reduction from bringing the lower of these two numbers to the reference safety stock.

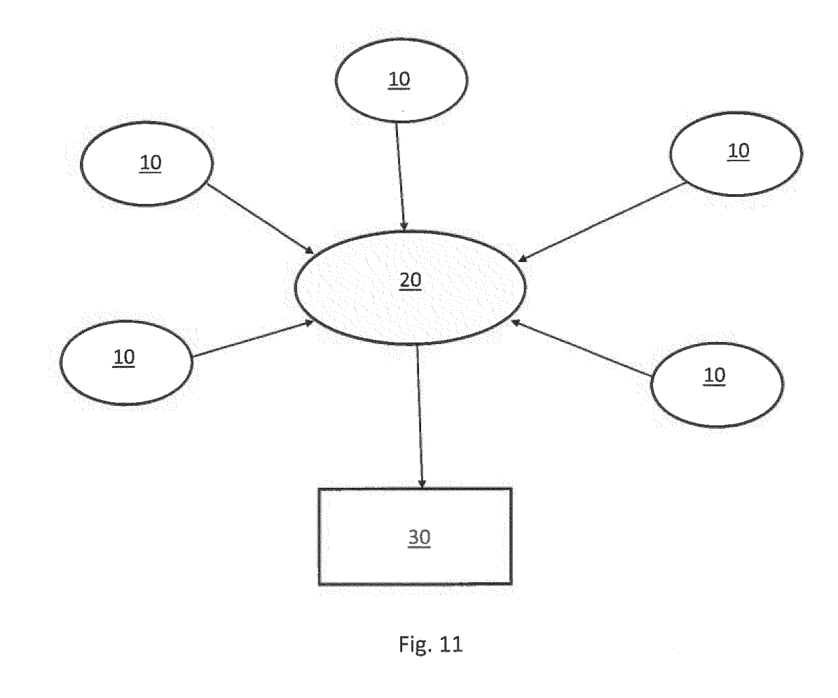

FIG. 11 illustrates a representative embodiment of a system for analyzing historical inventory layers in accordance with the disclosed subject matter. The system 20 is operatively coupled to the storage unit(s) 10. The system 20 may also be operatively couple to an inventory scheduler 30 or other suitable device such that the outputs derived from the system 20 can be input into the inventory scheduler 30 to assist with scheduling and ordering of material. The system 20 may include a memory device, a categorization module, an inventory layer determination engine, and a user interface.

Each of the components of the system can implemented as hardware or a combination of hardware and software. In an exemplary embodiment, at least some of the components constitute a physical device (i.e., hardware) that responds to instructions embodied in software. For example, the determination engine 1108 can be one or more processors that are programmed with instructions that, when executed, cause the one or more processors to determine an inventory layer. The instructions can be written in code. The term “code,” as used herein, embraces both source code and object code. The instructions can be embodied in a computer readable medium. The term “computer-readable medium” includes any mechanism for storing or transmitting information in a form readable by a computer. For example, a computer-readable medium includes, but is not limited to, read only memory (“ROM”), random access memory (“RAM”), magnetic disk storage media, optical storage media, flash memory devices, etc.

The measurement for each storage unit can be stored in a data file for the storage unit. For example, a storage unit data file can include an amount data field and a time data field for identifying when the measurement was taken.

The system includes a memory device that stores collection data from the storage units 10 and the inventory data calculated therefrom. The memory device can be any device that stores data. Examples of memory devices that can be used include internal hard drives, external hard drives, and removable storage devices such as compact discs, USB drives, and the like. In general, the memory device can be any suitable storage device as known in the art.

The memory device can store any data received or calculated by the system. For example, memory device can contain the amount of material for each storage unit, the activity status of each storage unit, an indication of material that has been allocated as safety stock, the reference safety stock amount, the inventory layer, the effective safety stock amount, or any other data described herein. The memory device can store the data fir each of the storage units in a data file for that storage unit including all information represented by FIGS. 1-10.

The system 20 includes a catergorization module that is configured to perform the calculations described above and categorize the activity status of each storage unit. In an exemplary embodiment, the categorization module may retrieves a data file from each facility for each storage unit and updates the historical data. The categorization module then categorizes the activity status fir the storage unit based on the historical data.

The determination engine is configured to determine an inventory layer based on the historical layers of material in each storage unit and the activity status of each storage unit. In an exemplary embodiment, the determination engine retrieves data files for each storage unit from the memory device. Using the information in the data files, the determination engine in connection with the categorization module allocates material to safety stock, determines the remaining material amounts, and determines an inventory layer based on this information in the manner described above. The determined inventory layer is then sent to the memory device for storage.

The system 20 also includes a user interface. The user interface may be an input device, an output device, or an input/output device. For example, the user interface can be a general purpose computer with a keyboard and a monitor. Information entered by the user (e.g., a reference safety stock amount) is input at the user interface and sent to other components for storage or use (e.g., by the determination engine). Similarly, the system 20 can retrieve data from the memory device and display it to the user via the user interface. Information displayed to the user by the user interface can include a histogram as shown in FIG. 8 or a savings/prize chart, as shown in FIG. 10.

The system can also include other hardware and/or software components for implemented the disclosed subject matter. For example, the system can additionally include a batch characteristic determination unit, a skewness determination unit, a potential volume reduction identifier, and any other module for implementing the disclosed methods.

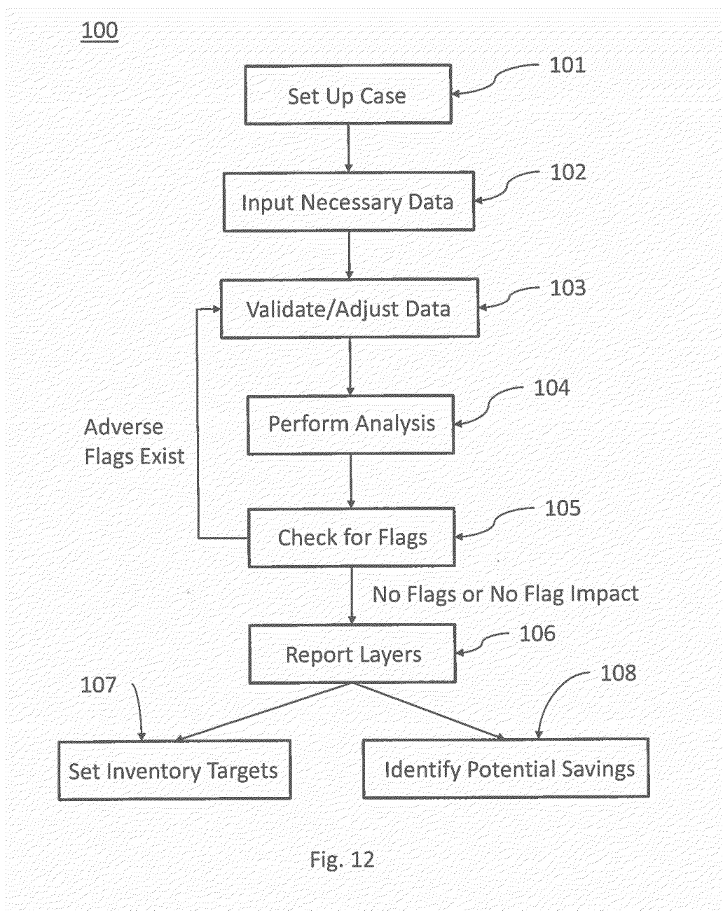

The methodology 100 for analyzing a segregation to identify inventory layers will now be described in greater detail in connection with the flow chart in FIG. 12. In Step 101, the user sets up the case for evaluation. In particular, the segregations and the storage unit(s) to evaluated. The relevant time frame for consideration is also identified. It is contemplated the user will input the parameters into the system 20 through a user interface (e.g., a computer terminal, which may house the system 20 or connected via a network to the system 20).

In Step 102, the necessary input data is input into the system 20. The necessary input date includes hourly storage unit inventory data within the relevant time frame and target safety stock values for the segregation. The input data also includes maintenance and other exceptions relating to the storage units during the relevant time frame. In accordance with the disclosed subject matter, it is contemplated that the system 20 may retrieve the data from remote databases from each facility containing one or more storage units 10. The data may also be retrieved from a central database contained within or linked to the system 20. Alternatively, the data can be input or uploaded by the user into the system 20. It is also contemplated that the user may adjust or modify the data to account for data that is missing or inaccurate due to inaccurate storage unit status (e.g., the data indicates that the storage unit is active when it is actually in a maintenance turn).

In Step 103, the input data is validated using visualization tools. The validation is performed by the user such that invalid or missing data may be indentified. Missing data, if necessary, may be input. Invalid data may be adjusted. It is contemplated that the system 20 performs the validation and the identification of the missing and/or invalid data is performed by the user.

In Step 104, the validated data is analyzed by the system 20 such that the data for the segregation is decomposed such that various layers can be identified in the manner described above. While it is preferred that this analysis is performed by the processor in the system 20, it is contemplated that the analysis may also be performed by the user.

In Step 105, a check for flags is performed. The flags identify whether or not all of the data was used in the analysis and whether or not any missing or invalid data adversely impacted the analysis of the segregation. The system will generate one or more flags if missing or invalid data is present or if an invalid segregation analysis is achieved. The use will then review the flags to determined whether or the generated flags are adverse. If the flag is adverse, then the Step 103 is reperformed with further adjustment/validation of the data being performed. If no flags are present or the determination is made that the flags generated were not adverse, then operation proceeds to Step 106. The data that is missing or not used may be highlighted in the display output in FIG. 7.

In Step 106, the layers of the segregation are reported to the user. The layers are output to the user as the representations shown for example in FIGS. 5, 6, 7 and 9. The output identifies the various states of the segregation during the time period of analysis and the makeup of the layers of the segregation. The user may then utilize the output of the layers to set inventory targets in Step 107. The user may also utilize the output to identify potential inventory savings or prizes in Step 108. In Step 108, the user utilizing the system 20 is able to determine whether or not any adjustments to the inventory layers of the segregation produce potential inventory savings or prizes. The system 20 displays the potential savings or prizes as output, as displayed for example in FIG. 10. The user then determines whether or not the savings is feasible. For example, the output may indicate that a storage unit could be eliminated resulting in a potential savings. Business reasons, however, may preclude the elimination of the storage unit. As such, the potential savings or prize would not be considered feasible.

While the present application is described herein in terms of certain preferred embodiments, those skilled in the art will recognize that various modifications and improvements may be made to the application without departing from the scope thereof. Thus, it is intended that the present application include modifications and variations that are within the scope of the appended claims and their equivalents. Moreover, although individual features of one embodiment of the application may be discussed herein or shown in the drawings of one embodiment and not in other embodiments, it should be apparent that individual features of one embodiment may be combined with one or more features of another embodiment or features from a plurality of embodiments.

The presently disclosed subject matter has been described in connection with each storage unit containing a single segregation. The presently disclosed subject matter is not intended to be so limited; rather, multiple segregations can be contained within a single storage unit and analyzed and categorized in a similar manner. For example, a storage unit containing a blend of materials can be analyzed with layers of the segregation being calculated in the manner described above. A portion of each layer of the segregation can be attributed to a particular material. For example, a segregation containing a blend of two materials (e.g., 70% light crude oil and 30% heavy crude oil) can be separated into separate segregations for heavy crude oil and light crude oil so that these materials can be properly analyzed and categorized. The materials are allocated based upon their percentages within the blend. As such, a safety stock calculated in the manner described above can be allocated as follows: 70% attributed to light crude oil and 30% attributed to heavy crude oil. The remaining layers can be allocated in similar proportions. Accordingly, it is possible to categorize inventory layers for complex blends of materials based upon the proportions of the materials contained therein.

In addition to the specific embodiments claimed below, the application is also directed to other embodiments having any other possible combination of the dependent features claimed below and those disclosed above. As such, the particular features presented in the dependent claims and disclosed above can be combined with each other in other manners within the scope of the application such that the application should be recognized as also specifically directed to other embodiments having any other possible combinations. Thus, the foregoing description of specific embodiments of the application has been presented for purposes of illustration and description. It is not intended to be exhaustive or to limit the application to those embodiments disclosed.

### Additional Embodiments

Embodiment 1. A method for identifying potential inventory savings for a segregation of a material by analyzing historical operational inventory layers for the segregation of the material in at least one storage unit at specified time intervals, comprising: obtaining historical operational data for a segregation of material in at least one storage unit, wherein the historical operational data corresponding to the specified time intervals; categorizing an activity status of each storage unit relating to the segregation at each of the specified time intervals; determining inventory layers for the inventory stored in the storage unit at the specified time interval; and identifying potential inventory savings for the segregation based upon the determined inventory layers.

### Embodiment 2

The method of Embodiment 1, wherein the potential inventory savings includes a potential volume reduction.

### Embodiment 3

The method of Embodiment 2, further comprising adjusting inventory layer targets based upon the identified potential inventory saving for the determined inventory layers.

### Embodiment 4

The method of Embodiment 1, wherein the potential inventory savings for the segregation is at least one of a cycle min stability, a cycle max stability, a cycle min target, an available static stock, and an excess idle stock.

### Embodiment 5

The method of Embodiment 4, further comprising adjusting inventory layer targets based upon the identified potential inventory saving for the determined inventory layers.

### Embodiment 6

A method of managing inventory layers for at least one storage unit storing inventory, comprising: (a) analyzing historical operational inventory layers for the least one storage unit at specified time intervals, wherein analyzing historical operational inventory layers comprising: obtaining historical operational data for at least one storage unit, wherein the historical operational data corresponding to the specified time intervals; categorizing an activity status of each storage unit at each of the specified time intervals; and determining inventory layers for the inventory stored in the storage unit at the specified time interval; (b) analyzing the determined inventory layers; and (c) adjusting inventory layer targets based upon the determined inventory layers.

### Embodiment 7

The method of Embodiment 6, wherein analyzing historical operational inventory layers further comprising: identifying potential inventory savings for the segregation based upon the determined inventory layers, wherein adjusting inventory layer targets includes adjusting inventory layer targets based upon the identified potential inventory saving for the determined inventory layers.

### Embodiment 8

The method of Embodiment 7, wherein the potential inventory savings for the segregation is at least one of a cycle min stability, a cycle max stability, a cycle min target, an available static stock, and an excess idle stock.

### Embodiment 9

A method for analyzing historical operational inventory layers for a segregation of material in at least one storage unit at specified time intervals, wherein each of the at least one storage unit storing inventory, comprising: obtaining historical operational data for a segregation of material in at least one storage unit, wherein the historical operational data corresponding to the specified time intervals; categorizing, using a processor, an activity status of each storage unit relating to the segregation at each of the specified time intervals; determining, using a processor, inventory layers for the inventory stored in the storage unit at the specified time interval.

### Embodiment 10

The method according to any one of the preceding Embodiments, wherein at least one of the categorizing the activity status of each storage unit and the determining inventory layers for the inventory stored in the storage unit is performed by a computer processor.

### Embodiment 11

The method according to any one of the preceding Embodiments, wherein categorizing the activity status of each storage unit comprises categorizing each storage unit as one of filling status, static status, withdrawing status, or idle status.

### Embodiment 12

The method according to Embodiment 11, wherein when the activity status of a storage unit is categorized as static at a specified time, the method further comprising: subcategorizing the static status as one of either available or unavailable.

### Embodiment 13

The method according to any one of the preceding Embodiments, wherein the inventory layers comprise: available static stock, unavailable static stock, idle stock, and cycle stock.

### Embodiment 14

The method according to Embodiment 13, wherein cycle stock includes withdrawing stock and filling stock.

### Embodiment 15

The method according to Embodiment 13, wherein determining inventory layers for the material stored in the storage unit at the specified time interval and the activity status of the at least one storage unit, comprising: establishing a reference safety stock for the inventory; allocating inventory to an effective safety stock; and determining inventory layers based upon any remaining inventory after allocating inventory to the effective safety stock.

### Embodiment 16

The method according to Embodiment 13, wherein allocating inventory to effective safety stock includes allocating available inventory.

### Embodiment 17

The method according to Embodiment 16, wherein available inventory includes idle stock, static available stock and withdrawing stock.

### Embodiment 18

The method according to Embodiment 17, wherein allocating available inventory to an effective safety stock includes allocating idle stock, then allocating static available stock and then withdrawing stock.

### Embodiment 19

The method according to any one of the preceding Embodiments, further comprising: identifying a multi-storage unit batch of inventory; and refining the activity status of at least one storage unit in the multi-storage unit batch.

### Embodiment 20

The method according to any one of the preceding Embodiments, wherein categorizing an activity status comprises categorizing the activity status of each storage unit based on historical operational data.

### Embodiment 21

The method of Embodiment 20, wherein the historical operational data comprises historical data regarding the amount of inventory stored in each storage unit at a specified time.

### Embodiment 22

The method according to any one of the preceding Embodiments, wherein determining an inventory layer comprises determining at least one of a cycle stock amount, a remaining unavailable static material amount, and an unavailable static material amount.

### Embodiment 23

The method according to any one of the preceding Embodiments, further comprising calculating an average inventory layer based on a number of periodic inventory layer determinations.

### Embodiment 24

The method according to any one of the preceding Embodiments, further comprising determining a batch characteristic.

### Embodiment 25

The method of Embodiment 24, wherein the batch characteristic is one of a drawable stock a min, an available stock at min, a stock at max, an available ullage at max, a batch size, a fill rate, and a draw rate.

### Embodiment 26

The method of Embodiment 25, further comprising determining a skewness of the histogram.

### Embodiment 27

The method of Embodiment 26, further comprising adjusting a fill point based on the skewness.

### Embodiment 28

The method of Embodiment further comprising adjusting a withdrawal point based on the skewness.

1. A method for identifying potential inventory savings for a segregation of a material by analyzing historical operational inventory layers for the segregation of the material in at least one storage unit at specified time intervals, comprising:
obtaining historical operational data for a segregation of material in at least one storage unit, wherein the historical operational data corresponding to the specified time intervals;
categorizing an activity status of each storage unit relating to the segregation at each of the specified time intervals;
determining inventory layers for the inventory stored in the storage unit at the specified time interval; and
identifying potential inventory savings for the segregation based upon the determined inventory layers.

2. The method of claim 1, wherein the potential inventory savings includes a potential volume reduction.

3. The method of claim 2, further comprising adjusting inventory layer targets based upon the identified potential inventory saving for the determined inventory layers.

4. The method of claim 1, wherein the potential inventory savings for the segregation is at least one of a cycle min stability, a cycle max stability, a cycle min target, an available static stock, and an excess idle stock.

5. The method of claim 4, further comprising adjusting inventory layer targets based upon the identified potential inventory saving for the determined inventory layers.

6. The method of claim 1, wherein at least one of the categorizing the activity status of each storage unit and the determining inventory layers for the inventory stored in the storage unit is performed by a computer processor.

7. The method of claim 1, wherein categorizing the activity status of each storage unit comprises categorizing each storage unit as one of filling status, static status, withdrawing status, or idle status.

8. The method according to claim 7, wherein when the activity status of a storage unit is categorized as static at a specified time, the method further comprising: subcategorizing the static status as one of either available or unavailable.

9. The method according to claim 1, wherein the inventory layers comprise: available static stock, unavailable static stock, idle stock, and cycle stock.

10. The method according to claim 9, wherein cycle stock includes withdrawing stock and filling stock.

11. The method according to claim 9, wherein determining inventory layers for the material stored in the storage unit at the specified time interval and the activity status of the at least one storage unit, comprising:
establishing a reference safety stock for the inventory;
allocating inventory to an effective safety stock; and
determining inventory layers based upon any remaining inventory after allocating inventory to the effective safety stock.

12. The method according to claim 11, wherein allocating inventory to effective safety stock includes allocating available inventory.

13. The method according to claim 12, wherein available inventory includes idle stock, static available stock and withdrawing stock.

14. The method according to claim 13, wherein allocating available inventory to an effective safety stock includes allocating idle stock, then allocating static available stock and then withdrawing stock.

15. The method according to claim 1, further comprising:
identifying a multi-storage unit batch of inventory; and
refining the activity status of at least one storage unit in the multi-storage unit batch.

16. The method according to claim 15, wherein the inventory layers comprise: available static stock, unavailable static stock, idle stock, and cycle stock.

17. The method according to claim 16, wherein cycle stock includes withdrawing stock and filling stock.

18. The method according to claim 17, wherein determining inventory layers for the material stored in the storage unit at the specified time interval and the activity status of the at least one storage unit, comprising:
establishing a reference safety stock for the inventory;
allocating inventory to an effective safety stock; and
determining inventory layers based upon any remaining inventory after allocating inventory to the effective safety stock.

19. The method according to claim 18, wherein allocating inventory to effective safety stock includes allocating available inventory.

20. The method according to claim 119, wherein available inventory includes idle stock, static available stock and withdrawing stock.

21. The method according to claim 20, wherein allocating available inventory to an effective safety stock includes allocating idle stock, then allocating static available stock and then withdrawing stock.

22. The method of claim 1, wherein categorizing an activity status comprises categorizing the activity status of each storage unit based on historical operational data.

23. The method of claim 22, wherein the historical operational data comprises historical data regarding the amount of inventory stored in each storage unit at a specified time.

24. The method of claim 1, wherein determining an inventory layer comprises determining at least one of a cycle stock amount, a remaining unavailable static material amount, and an unavailable static material amount.

25. The method of claim 1, further comprising calculating an average inventory layer based on a number of periodic inventory layer determinations.

26. The method of claim 1, further comprising determining a batch characteristic.

27. The method of claim 26, wherein the batch characteristic is one of a drawable stock at min, an available stock at min, a stock at max, an available ullage at max, a batch size, a fill rate, and a draw rate.

28. The method of claim 27, further comprising determining a skewness of the histogram.

29. The method of claim 28, further comprising adjusting a fill point based on the skewness.

30. The method of claim 28, further comprising adjusting a withdrawal point based on the skewness.

31. A method of managing inventory layers for at least one storage unit storing inventory, comprising:
(a) analyzing historical operational inventory layers for the least one storage unit at specified time intervals, wherein analyzing historical operational inventory layers comprising:
obtaining historical operational data for at least one storage unit, wherein the historical operational data corresponding to the specified time intervals;
categorizing an activity status of each storage unit at each of the specified time intervals; and
determining inventory layers for the inventory stored in the storage unit at the specified time interval;
(b) analyzing the determined inventory layers; and
(c) adjusting inventory layer targets based upon the determined inventory layers.

32. The method of claim 31, wherein at least one of the categorizing the activity status of each storage unit and the determining inventory layers for the inventory stored in the storage unit is performed by a computer processor.

33. The method of claim 31, wherein categorizing the activity status of each storage unit comprises categorizing each storage unit as one of filling status, static status, withdrawing status, or idle status.

34. The method according to claim 33, wherein when the activity status of a storage unit is categorized as static at a specified time, the method further comprising: subcategorizing the static status as one of either available or unavailable.

35. The method according to claim 34, wherein the inventory layers comprise: available static stock, unavailable static stock, idle stock, and cycle stock.

36. The method according to claim 35, wherein cycle stock includes withdrawing stock and filling stock.

37. The method according to claim 35, wherein determining inventory layers for the material stored in the storage unit at the specified time interval and the activity status of the at least one storage unit, comprising:
establishing a reference safety stock for the inventory;
allocating inventory to an effective safety stock; and
determining inventory layers based upon any remaining inventory after allocating inventory to the effective safety stock.

38. The method according to claim 37, wherein allocating inventory to effective safety stock includes allocating available inventory.

39. The method according to claim 38, wherein available inventory includes idle stock, static available stock and withdrawing stock.

40. The method according to claim 39, wherein allocating available inventory to an effective safety stock includes allocating idle stock, then allocating static available stock and then withdrawing stock.

41. The method according to claim 31, wherein analyzing historical operational inventory layers comprising:
identifying a multi-storage unit batch of inventory; and
refining the activity status of at least one storage unit in the multi-storage unit batch.

42. The method according to claim 41, wherein the inventory layers comprise: available static stock, unavailable static stock, idle stock, and cycle stock.

43. The method according to claim 42, wherein cycle stock includes withdrawing stock and filling stock.

44. The method according to claim 43, wherein determining inventory layers for the material stored in the storage unit at the specified time interval and the activity status of the at least one storage unit, comprising:
establishing a reference safety stock for the inventory;
allocating inventory to an effective safety stock; and
determining inventory layers based upon any remaining inventory after allocating inventory to the effective safety stock.

45. The method according to claim 44, wherein allocating inventory to effective safety stock includes allocating available inventory.

46. The method according to claim 45, wherein available inventory includes idle stock, static available stock and withdrawing stock.

47. The method according to claim 46, wherein allocating available inventory to an effective safety stock includes allocating idle stock, then allocating static available stock and then withdrawing stock.

48. The method of claim 31, wherein categorizing an activity status comprises categorizing the activity status of each storage unit based on historical operational data.

49. The method of claim 48, wherein the historical operational data comprises historical data regarding the amount of inventory stored in each storage unit at a specified time.

50. The method of claim 31, wherein determining an inventory layer comprises determining at least one of a cycle stock amount, a remaining unavailable static material amount, and an unavailable static material amount.

51. The method of claim 31, wherein analyzing historical operational inventory layers further comprising: calculating an average inventory layer based on a number of periodic inventory layer determinations.

52. The method of claim 31, wherein analyzing historical operational inventory layers further comprising: determining a batch characteristic.

53. The method of claim 52, wherein the batch characteristic is one of a drawable stock a min, an available stock at min, a stock at max, an available ullage at max, a batch size, a fill rate, and a draw rate.

54. The method of claim 53, further comprising determining a skewness of the histogram.

55. The method of claim 54, further comprising adjusting a fill point based on the skewness.

56. The method of claim 55, further comprising adjusting a withdrawal point based on the skewness.

57. The method of claim 31, wherein analyzing historical operational inventory layers further comprising: identifying potential inventory savings for the segregation based upon the determined inventory layers, wherein adjusting inventory layer targets includes adjusting inventory layer targets based upon the identified potential inventory saving for the determined inventory layers.

58. The method of claim 57, wherein the potential inventory savings for the segregation is at least one of a cycle min stability, a cycle max stability, a cycle min target, an available static stock, and an excess idle stock.

59. A method for analyzing historical operational inventory layers for a segregation of material in at least one storage unit at specified time intervals, wherein each of the at least one storage unit storing inventory, comprising:
obtaining historical operational data for a segregation of material in at least one storage unit, wherein the historical operational data corresponding to the specified time intervals;
categorizing, using a processer, an activity status of each storage unit relating to the segregation at each of the specified time intervals;
determining, using a processor, inventory layers for the inventory stored in the storage unit at the specified time interval.

60. The method of claim 59, wherein at least one of the categorizing the activity status of each storage unit and the determining inventory layers for the inventory stored in the storage unit is performed by a computer processor.

61. The method of claim 59, wherein categorizing the activity status of each storage unit comprises categorizing each storage unit as one of filling status, static status, withdrawing status, or idle status.

62. The method according to claim 61, wherein when the activity status of a storage unit is categorized as static at a specified time, the method further comprising: subcategorizing the static status as one of either available or unavailable.

63. The method according to claim 59, wherein the inventory layers comprise: available static stock, unavailable static stock, idle stock, and cycle stock.

64. The method according to claim 63, wherein cycle stock includes withdrawing stock and filling stock.

65. The method according to claim 63, wherein determining inventory layers for the material stored in the storage unit at the specified time interval and the activity status of the at least one storage unit, comprising:
establishing a reference safety stock for the inventory;
allocating inventory to an effective safety stock; and
determining inventory layers based upon any remaining inventory after allocating inventory to the effective safety stock.

66. The method according to claim 65, wherein allocating inventory to effective safety stock includes allocating available inventory.

67. The method according to claim 66, wherein available inventory includes idle stock, static available stock and withdrawing stock.

68. The method according to claim 67, wherein allocating available inventory to an effective safety stock includes allocating idle stock, then allocating static available stock and then withdrawing stock.

69. The method according to claim 59, further comprising:
identifying a multi-storage unit batch of inventory; and
refining the activity status of at least one storage unit in the multi-storage unit batch.

70. The method according to claim 69, wherein the inventory layers comprise:
available static stock, unavailable static stock, idle stock, and cycle stock.

71. The method according to claim 70, wherein cycle stock includes withdrawing stock and filling stock.

72. The method according to claim 71, wherein determining inventory layers for the material stored in the storage unit at the specified time interval and the activity status of the at least one storage unit, comprising:
establishing a reference safety stock for the inventory;
allocating inventory to an effective safety stock; and
determining inventory layers based upon any remaining inventory after allocating inventory to the effective safety stock.

73. The method according to claim 72, wherein allocating inventory to effective safety stock includes allocating available inventory.

74. The method according to claim 73, wherein available inventory includes idle stock, static available stock and withdrawing stock.

75. The method according to claim 74, wherein allocating available inventory to an effective safety stock includes allocating idle stock, then allocating static available stock and then withdrawing stock.

76. The method of claim 59, wherein categorizing an activity status comprises categorizing the activity status of each storage unit based on historical operational data.

77. The method of claim 76, wherein the historical operational data comprises historical data regarding the amount of inventory stored in each storage unit at a specified time.

78. The method of claim 59, wherein determining an inventory layer comprises determining at least one of a cycle stock amount, a remaining unavailable static material amount, and an unavailable static material amount.

79. The method of claim 59, further comprising calculating an average inventory layer based on a number of periodic inventory layer determinations.

80. The method of claim 59, further comprising determining a batch characteristic.

81. The method of claim 80, wherein the batch characteristic is one of a drawable stock a min, an available stock at min, a stock at max, an available ullage at max, a batch size, a fill rate, and a draw rate.

82. The method of claim 81, further comprising determining a skewness of the histogram.

83. The method of claim 82, further comprising adjusting a fill point based on the skewness.

84. The method of claim 82, further comprising adjusting a withdrawal point based on the skewness.

85. The method of claim 59, further comprising:
analyzing the determined inventory layers, wherein the analyzing includes identifying potential inventory savings for the segregation based upon the determined inventory layers; and
adjusting inventory layer targets based upon the identified potential inventory saving for the determined inventory layers.

86. The method of claim 85, wherein the potential inventory savings for the segregation is at least one of a cycle min stability, a cycle max stability, a cycle min target, an available static stock, and an excess idle stock.
